(19) United States
(12) Patent Application Publication
(10) Pub. No.: US 2013/0046720 A1
(43) Pub. Date: Feb. 21, 2013

(54) DOMAIN BASED USER MAPPING OF OBJECTS

(71) Applicants: Natarajan Chellappan, Bangalore (IN); Madhusudanan Kandasamy, Gobichettipalayam (IN); Vidya Ranganathan, Bangalore (IN); Lakshmanan Velusamy, Vedichipalayam (IN)

(72) Inventors: Natarajan Chellappan, Bangalore (IN); Madhusudanan Kandasamy, Gobichettipalayam (IN); Vidya Ranganathan, Bangalore (IN); Lakshmanan Velusamy, Vedichipalayam (IN)

(73) Assignee: INTERNATIONAL BUSINESS MACHINES CORPORATION, Armonk, NY (US)

(21) Appl. No.: 13/212,024

(22) Filed: Aug. 17, 2011

(51) Int. Cl. G06N 5/02

(52) U.S. Cl. 706/47

(57) ABSTRACT

According to one aspect of the present disclosure, a method and technique for domain based user mapping of objects is disclosed. The method includes: responsive to determining that an operation is being attempted on an object identified with an object identifier, determining a domain identifier associated with a user attempting the operation; determining whether the operation can proceed on the object based on domain isolation rules, the domain isolation rules indicating rules for allowing or disallowing operations to proceed on objects based on object identifiers and domain identifiers; responsive to determining that the operation on the object can proceed based on the domain isolation rules, accessing user mapping rules that map specified users allowed to perform a specified operation to a specified object; and determining whether the operation can proceed on the object by the user based on the user mapping rules.

### BACKGROUND

In some operating systems, such as a UNIX or UNIX-like operating system, access control mechanisms may be used to control access to certain objects (e.g., files, reports, databases and/or system resources). For example, in a UNIX or UNIX-like operating system, system administration activities are typically performed through a root user account. System administrators responsible for the administration of the system share and/or manage the password to the root account or use access control tools which allow access to the desired services/objects after authentication has been provided. An additional level of access control granularity may be provided utilizing domains. Domains is a mechanism of associating tags to objects that allow or disallow users with those tags attached to them access to the object for a particular action based on a set of governing rules.

### BRIEF SUMMARY

According to one aspect of the present disclosure a method and technique for domain based user mapping of objects is disclosed. The method includes: responsive to determining that an operation is being attempted on an object identified with an object identifier, determining a domain identifier associated with a user attempting the operation; determining whether the operation can proceed on the object based on domain isolation rules, the domain isolation rules indicating rules for allowing or disallowing operations to proceed on objects based on object identifiers and domain identifiers; responsive to determining that the operation on the object can proceed based on the domain isolation rules, accessing user mapping rules that map specified users allowed to perform a specified operation to a specified object; and determining whether the operation can proceed on the object by the user based on the user mapping rules.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a data processing system for domain based user mapping of objects in which illustrative embodiments of the present disclosure may be implemented; and

FIG. 4 is a flow diagram illustrating an embodiment of a method for domain based user mapping of objects.

### DETAILED DESCRIPTION

Embodiments of the present disclosure provide a method and technique for domain based user mapping of objects. For example, in some embodiments, the method and technique includes: responsive to determining that an operation is being attempted on an object identified with an object identifier, determining a domain identifier associated with a user attempting the operation; determining whether the operation can proceed on the object based on domain isolation rules, the domain isolation rules indicating rules for allowing or disallowing operations to proceed on objects based on object identifiers and domain identifiers; responsive to determining that the operation on the object can proceed based on the domain isolation rules, accessing user mapping rules that map specified users allowed to perform a specified operation to a specified object; and determining whether the operation can proceed on the object by the user based on the user mapping rules. Embodiments of the present disclosure enable additional granular access control for objects utilizing domain based access control for objects by mapping particular users to an object for specified operations. Embodiments of the present disclosure enable additional granular access control for objects by providing an additional layer of granularity control with a domain based access control system.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

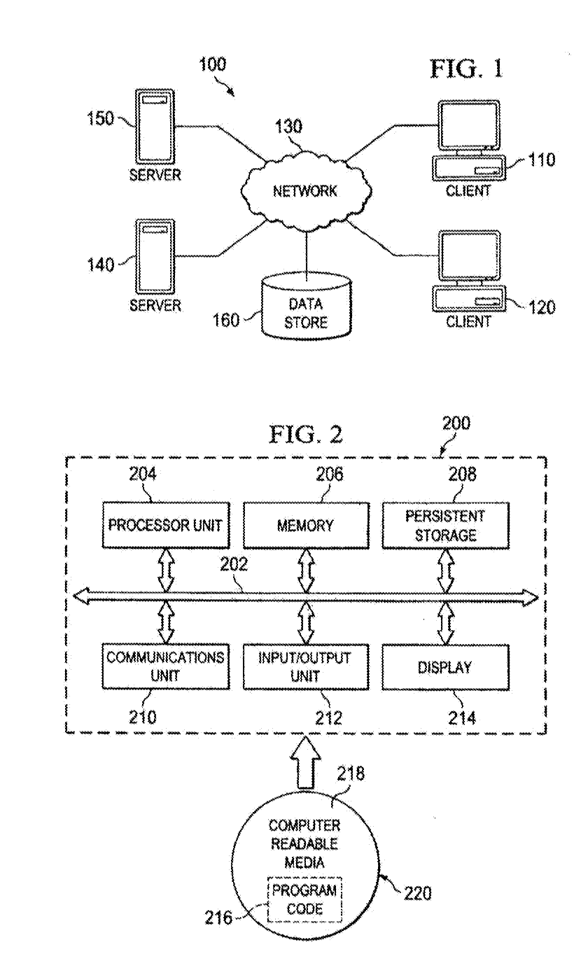

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. Server 140 and server 150 may be, for example, IBM System p® servers. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 and/or server 140 in which an embodiment of a data transfer management system according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

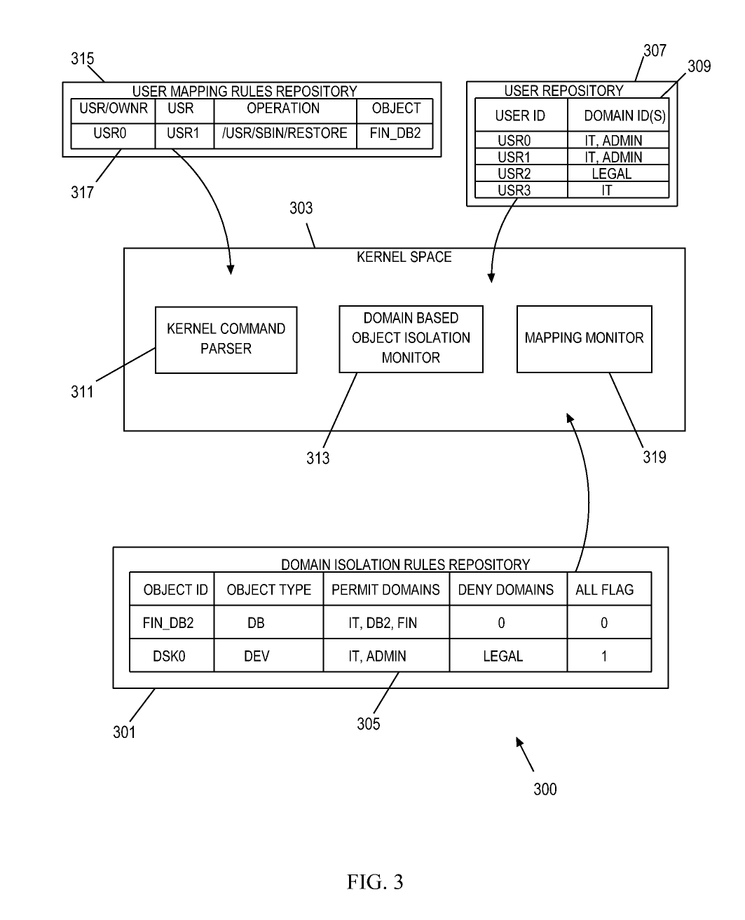

FIG. 3 is an illustrative embodiment of a system 300 for domain based user mapping of objects. System 300 may be implemented on data processing systems or platforms such as, but not limited to, servers 140 and/or 150, clients 110 and/or 120, or at other data processing system locations. The terms “application,” “tool,” “utility,” and “script” are used herein to refer to one or more computer programs. The terms “process” and “instance” are used hereinto refer to an executing computer program or executing part of a computer program. To illustrate, an “operating system instance” refers to an instantiated or executing operating system computer program. A “kernel process” refers to a kernel program or kernel service executing in kernel space. “Kernel space” refers to the execution space of the kernel. The description also uses the term “subject” to refer to executing instances of kernel code, application code, a utility, or a tool.

An operating system (“OS”) can support access to objects (e.g., devices, file systems, volume groups, files, etc.) for different departments of an organization and for different purposes (e.g., management of the object, writing to the object, viewing the object, invoking an object, etc.). For instance, an OS can support different applications/systems and data for a legal department, a human resources (“HR”) department, and a finance department. The OS can support an electronic mail system for all three departments. The OS can also support a docketing application for the legal department and a bookkeeping application for the finance department. The OS may also support a job application database for the HR department. An organization may want to isolate the objects for the different departments. An administrator can create domains for these different departments to isolate the objects of the departments (e.g., database records, department file systems, etc.) for confidentiality reasons, to conform to organizational task divisions (e.g., different information technology departments may support the different departments), etc.

Functionality can be implemented in an OS to increase the granularity of isolation for objects. A domain can be defined to represent each of different entities (e.g., different departments or work groups). User identifiers and/or user credentials can be associated with the appropriate domain or domains. For instance, an administrator can configure users as members of particular domains. An administrator can then define a set of rules that govern operation(s) that can be performed on the objects based on the domains. The operations can be in response to commands or instructions from an executing application, executing script, process, etc. Processes or subjects running on a system will inherit the domain or domains of a user account logged into the system. A kernel process, for example, can evaluate the set of rules that specify which domains facilitate access to which objects. When a process or subject attempts to perform an operation on an object (e.g., mount a file system or device, create a volume group, view or write to a file, etc.), the kernel process evaluates the domain inherited by the process, and consequently the operation, and the object against the set of rules to determine whether the operation is permitted to proceed.

In FIG. 3, a kernel space 303 comprises a kernel command parser 311, a domain based object isolation monitor 313 and a mapping monitor 319. Kernel command parser 311, domain based object isolation monitor 313 and mapping monitor 319 may be implemented in any suitable manner that may be hardware-based, software-based, or some combination of both. For example, kernel command parser 311, domain based object isolation monitor 313 and mapping monitor 319 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). The kernel space 303 represents memory and processes of a kernel on a machine. The kernel command parser 311 represents executing kernel code that parses commands/instructions initiated in user space of the machine hosting the kernel space 303. Although a kernel command parser 311 is not necessarily involved in receiving a command or instruction from user space, FIG. 3 depicts an example involving a command parser to avoid encumbering the description with alternatives.

The machine that hosts the kernel space 303 is communicatively coupled with a user repository 307. The user repository 307 hosts user data (e.g., user credentials, user profiles, etc.) of users that login into the machine. The user data may at least include user identifiers (e.g., usernames, serial numbers, etc.) and associated domains. Each user can be associated with 0 to n domains. When a user is assigned or associated with a domain, the system that manages the user repository 307 updates the corresponding user data to indicate the domain. For instance, a system that supports the creation of domains submits a request to the system that supports the user repository 307 to update a user profile, for example, to indicate a domain. The user repository 307 may be local to the machine that hosts the kernel space 303. The user repository 307 may be distributed throughout a cluster or hosted at a device designated for hosting the user data accessible via a network. The machine also has access to a domain isolation rules repository 301. The domain isolation rules repository 301 comprises domain isolation rules that indicate which domains are permitted for which objects. A storage device that hosts the domain isolation rules repository 301 can be local or remote with respect to the machine that hosts the kernel space 303.

A root user, super user, or a user with a highest privilege can create domains and domain isolation rules. For instance, a root user can create a domain for IT administrators. The root user can also create a database domain. The root user can define a rule that allows access to manage database objects for users who are assigned to both the IT administrator domain and the database domain. The root user can also define a rule that allows access to manage email objects (e.g., email servers) for users assigned to the IT administrator domain and an “email” domain previously created by the root user.

Defining a domain can comprise establishing an identifier for a domain (e.g., a domain name, a unique numerical identifier, etc.) and a description of the domain. A system that hosts a repository of domains can enforce uniqueness of domain identifiers as unique names and/or generate unique numbers for domains across a node or network. Defining a domain isolation rule comprises indicating an object and a domain(s) that facilitates performance of operation on the object (“permitted domain”). Defining a rule can also comprise specifying a domain that does not facilitate performance of an operation (“denied domain”) on the object. For instance, a user may be assigned to an IT domain and a LEGAL domain. A rule may allow a management operation on a particular object if the operation is associated with a user who is a member of the IT domain and an HR domain. A rule may specify that the IT domain is a permitted domain, but the LEGAL domain is a denied domain. Even though the user is a member of the IT domain, an operation associated with the user is not allowed to be performed on an object governed by the rule because the user is also a member of a denied domain. Embodiments can also indicate a flag that represents a constraint of “ANY” or “ALL” domains for an object in a domain isolation rule. If the ALL flag is set in a rule, then an operation associated with a user who is a member of all of the permitted domains indicated in the rule can be performed. Membership in only one of the permitted domains would be insufficient. The ANY or ALL flag can be represented by a single bit or a complex structure. For example, a value of 1 can indicate that ALL domains are required, while a value of 0 can indicate that ANY of the permitted domains is sufficient.

Returning to the example depicted in FIG. 3, a set of domain isolation rules 305 are loaded into the kernel space 303 from the domain isolation rules repository 301. Although embodiments can load all of the domain isolation rules into the kernel space 303, embodiments can also limit loading to a subset of the rules. In addition, the domain isolation rules repository may index or organize rules by various criteria. For example, a set of domain isolation rules can be associated with a particular machine. As another example, domain isolation rules can be loaded after login based on domain membership or credentials of the user that logs into the machine.

User information is loaded into the kernel space 303 from the user repository 307 responsive to a user logging into the machine that hosts the kernel space 303. The user information loaded into the kernel space 303 is instantiated as a user structure instance 309. The user structure instance 309 at least indicates a user identifier and a domain associated with the user represented by the user identifier. In this example, the user repository 307 illustrates four different users identified as “USR0,” “USR1,” “USR3” and USR4.” It should be understood that a fewer or greater number of users may be represented. USR0 and USR1 are members of the IT domain and the ADMIN domain, USR2 is a member of the LEGAL domain, and USR4 is a member of the IT domain. Kernel command parser 311 receives an instruction from user space that targets an object. For example, a user may enter a request to mount a device or increase the size of a filesystem. The kernel command parser 311 passes an identifier of the object targeted by the instruction to the domain based object isolation monitor 313. For instance, the kernel command parser can call a function that implements the domain based object isolation monitor with the object identifier passed as a parameter. As another example, the kernel command parser 311 can receive a message through a system call which indicates the object identifier to the domain based object isolation monitor 313. The domain based object isolation monitor 313 determines whether the instruction can be applied to the object (i.e., whether the one or more operations that implement the instruction can be performed on the object) based on the domain(s) of the user associated with the instruction. The domain based object isolation monitor 313 accesses the set of domain isolation rules 305. The set of domain isolation rules 305 indicates an object identifier, an object type, permitted domains, denied or conflict domains, and an ANY or ALL flag. In the illustrated embodiment, the set of domain isolation rules 305 includes a rule that indicates a database object “FIN_DB2” can be operated upon by an operation(s) associated with anyone of the domains IT, DB2, and finance (“FIN”). The set of domain isolation rules 305 also includes a rule that permits access to a device object “DSK0” by an operation(s) associated with a user who is a member of all of the domains IT and ADMIN. Since the USR0 is a member of both the IT domain and the ADMIN domain, a command/instruction that targets the device DSK0 would be permitted to proceed.

As illustrated in FIG. 3, the machine also has access to a user mapping rules repository 315. The user mapping rules repository 315 comprises a set of mapping rules 317 that map or specify, for a particular object, which users are permitted to perform designated operations. In the embodiment illustrated in FIG. 3, the mapping rules 317 include a mapping designation based on the owner or creator of the object. For example, in some embodiments, the owner or creator of the object may create an entry in the user mapping rules repository 315 upon object creation or otherwise designating particular operations that may be performed on the object by particular users. It should be understood that an IT administrator or other process may be used to generate and store the mapping rules 317. There can be a 1:1 mapping or a 1:n mapping between users and the specified objects for a particular operation. For example, in the embodiment illustrated in FIG. 3, USR0 is the creator/owner of the specified object FIN_DB2 which may comprise a backup archive or any other type of object. In the mapping rules 317 illustrated in FIG. 3, user USR1 is mapped to the object FIN_DB2 for the operation “/usesbin/restore” which may relate to a restore operation for the backup archive. User USR0 maps to user USR1 on object FIN_DB2 to enable user USR1 access to perform an operation on object FIN_DB2. Thus, for example, an owner and/or creator of an object maps to one or more other users for the object to allow access by the other users to perform an operation on the object based on domain rules only when such mapping exists for the designated users. Therefore, a user who may otherwise satisfy discretionary access control permissions and has domain rules satisfied but does not have mapping will be denied access for the operation. In the embodiment illustrated in FIG. 3, only a single user (USR1) is mapped to object FIN_DB2 for the designated operation; however, it should be understood that the mapping designation may include multiple users for the designated operation on the designated object. A storage device that hosts the user mapping rules repository 315 can be local or remote with respect to the machine that hosts the kernel space 303.

The set of mapping rules 317 are loaded into the kernel space 303 from the user mapping rules repository 315. Although embodiments can load all of the mapping rules 317 into the kernel space 303, embodiments can also limit loading to a subset of the rules. In addition, the user mapping rules repository 315 may index or organize rules by various criteria. For example, a set of mapping rules 317 can be associated with a particular machine. As another example, user mapping rules can be loaded after login based on domain membership or credentials of the user that logs into the machine. If the domain based object isolation monitor 313 determines that the instruction can be applied to the object (i.e., whether the one or more operations that implement the instruction can be performed on the object) based on the domain(s) of the user associated with the instruction (e.g., based on the set of domain isolation rules 305), the kernel command parser 311 passes an identifier of the object targeted by the instruction to the mapping monitor 319. The mapping monitor 319 determines whether the instruction can be applied to the object (i.e., whether the one or more operations that implement the instruction can be performed on the object) based on the mapping of specified users to specified objects for specified operations. The mapping monitor 319 accesses the set of mapping rules 317 and evaluates whether the instruction can be applied to the object based on the user associated with the instruction. For example, in the illustrated embodiment, the object FIN_DB2 may be operated on by users that are members of the IT, DB2 or FIN domains. Thus, in the illustrated example, users USR1 and USR3 would be permitted to perform an operation on object FIN_DB2 based on the set of domain isolation rules 305 (e.g., users USR1 and USR3 both being members of the IT domain) created by USR0. However, based on the set of user mapping rules 317, for the object FIN_DB2, only USR1 would be permitted to perform the operation “/usesbin/restore” on the object FIN_DB2. Thus, even though USR3 is a member of a permitted domain for the object FIN_DB2, USR3 would not be permitted to perform the “/usesbin/restore” operation on the object FIN_DB2. It should also be understood that the above-referenced process may be performed in a different order (e.g., validation of mapping rules 317 by mapping monitor 319 followed by validation by domain based object isolation monitor 313).

Although the depicted example refers to a command, embodiments are not so limited. Embodiments can determine whether an operation being performed by an application is permitted to operate upon or access an object. The application would be executing as a process in a user space invoked by a user. The application process inherits the domain of the user. Thus, the corresponding domain identifier of that user would be used to evaluate the set of domain isolation rules and the mapping rules against the operation for the object. In addition, embodiments are not limited to specifying particular object identifiers. An administrator can define a rule that governs access to manage types of objects.

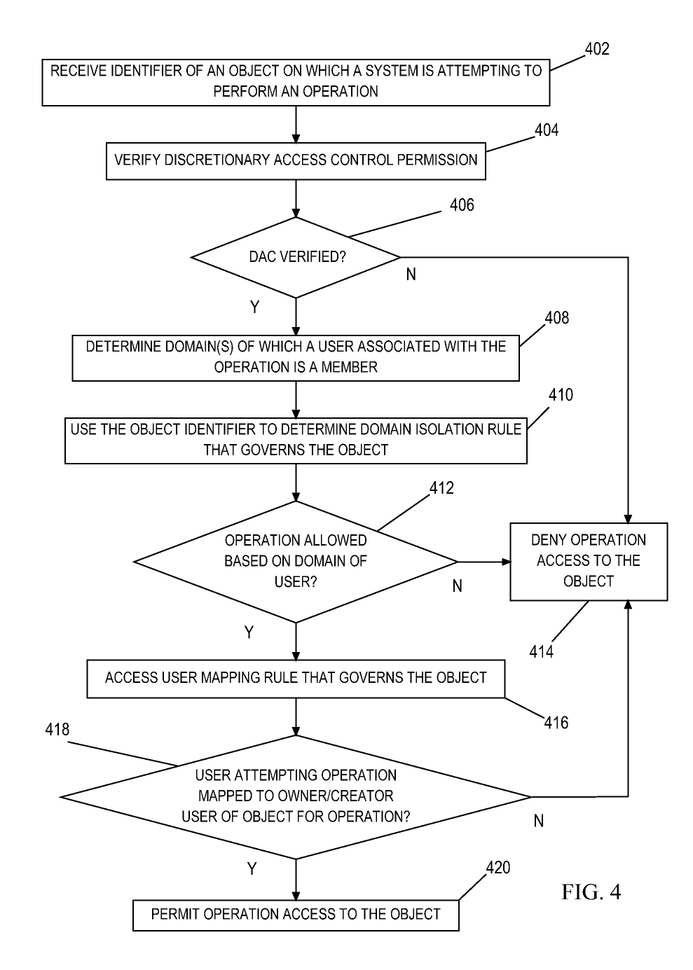

FIG. 4 is a flow diagram illustrating an embodiment of a method for domain based user mapping of objects. The method begins at block 402, where an object identifier is received that identifies an object on which a system is attempting to perform an operation(s). The object identifier identifies an object that is targeted by a command, an application, an instruction, invoked function, etc. For example, the user may be attempting to create an archive or update a database. As stated earlier, the object identifier may be indicated in a function call, an instruction in an executing script, an operation originating from a utility, an application, etc. The set of one or more operations may be implementing a command or instruction that originates from a command line, application instance, operating system process, background process, etc.

At block 404, discretionary access control (DAC) permission is verified. For example, in some embodiments, special authorizations may be used where a user wants to provide execution access to an owner, group, or all users based on the user's identity in a role based access control environment. In this embodiment, for example, DAC is provided using the traditional file object permission bit method of owner/group/other and read/write/execute. By using file object permission bits, an individual user determines whether another user or group needs access to the data in a particular file object. This type of access is based on the userid and the groupid(s) to which a user belongs. Thus, a file system object may have associated permissions to describe access for the owner, group, and others. At decisional block 406, a determination is made whether DAC permission has been verified. If not, the method proceeds to block 414, where an indication of a denial of operation access to the object is provided. If DAC permission is verified, the method proceeds to block 408.

At block 408, domain(s) to which the user belongs is determined. For example, the user may be a member of a human resources domain. When user data (e.g., credentials, profile, etc.) that represents a user account logged into a system is loaded, the domain identifier(s) indicated in the user data can be stored at a known or reserved location in the operating system space. When evaluating a domain isolation rule, an operating system process can access the known or reserved operating system space location for the domain identifier(s). At block 410, the object identifier is used to determine a domain isolation rule that governs the object. A set of domain isolation rules can be indexed by object identifiers. For example, a kernel process locates a domain isolation rule using the object identifier as an index.

At decisional block 412, a determination is made whether the operation being attempted can be performed on the object based on domain membership. A kernel process evaluates the located domain isolation rule for the object and determines whether the domain of the user is indicated as a permitted domain. The kernel process may also determine whether the rule indicates that a user is required to be a member of all indicated permitted domains, or if the user is a member of a denied or conflict domain. If operation is not permitted to be performed on the object based on domain membership of the user, the method proceeds to block 414, where an indication of a denial of operation access to the object is provided. If the operation is permitted to be performed on the object based on domain membership of the user, the method proceeds to block 416.

At block 416, mapping rules are accessed to determine whether the user attempting the operation is mapped to the object for the requested operation. At decisional block 418, a kernel process (e.g., mapping monitor 319) evaluates the mapping rule for the object and determines whether the user attempting the operation on the object is mapped to the user who created or owns the object for the requested operation. If the user attempting the operation on the object is not mapped to the user who owns or created the object for the requested operation based on the mapping rule, the method proceeds to block 414, where an indication of a denial of operation access to the object is provided. If the user attempting the operation on the object is mapped to the user who owns or created the object for the requested operation based on the mapping rule, the method proceeds to block 420, where access to the object for the requested operation is permitted.

Thus, embodiments of the present disclosure enable additional granular access control for objects while reducing system administration time. Further, embodiments of the present disclosure enable additional granular access control for objects by providing an additional layer of granularity control with a domain based access control system.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method, comprising:
responsive to determining that an operation is being attempted on an object identified with an object identifier, determining a domain identifier associated with a user attempting the operation;
determining whether the operation can proceed on the object based on domain isolation rules, the domain isolation rules indicating rules for allowing or disallowing operations to proceed on objects based on object identifiers and domain identifiers;
responsive to determining that the operation on the object can proceed based on the domain isolation rules, accessing user mapping rules that map specified users allowed to perform a specified operation to a specified object; and
determining whether the operation can proceed on the object by the user based on the user mapping rules.

2. The method of claim 1, further comprising:
associating a user identifier with the user; and
associating the user identifier with the domain identifier.

3. The method of claim 1, further comprising:
determining whether the user is mapped to the operation based on the user mapping rules; and
responsive to determining that the user is not mapped to the operation, denying the operation.

4. The method of claim 1, further comprising:
determining whether the user is mapped to the operation based on the user mapping rules; and
responsive to determining that the user is mapped to the operation, permitting the operation.

5. The method of claim 1, further comprising:
storing a mapping of users permitted to perform the operation on the object; and
determining whether the user attempting to perform the operation on the object is included in the stored mapping.

6. The method of claim 1, further comprising:
storing a mapping of users permitted to perform the operation on the object based on an owner of the object; and
determining whether the user attempting to perform the operation on the object is included in the stored mapping.

7. The method of claim 1, further comprising:
storing the user mapping rules to include, for each user mapping rule, an owner of a mapped object, a mapped operation that may be performed on the mapped object, and an identification of one or more mapped users permitted access to the mapped object for the mapped operation; and
wherein determining whether the operation can proceed on the object by the user comprises verifying the user attempting the operation is a mapped user and that the operation being attempted is a mapped operation.

8. A system, comprising:
a processor;
a domain based object isolation monitor executable by the processor to:
responsive to determining that an operation is being attempted on an object identified with an object identifier, determine a domain identifier associated with a user attempting the operation; and
determine whether the operation can proceed on the object based on domain isolation rules, the domain isolation rules indicating rules for allowing or disallowing operations to proceed on objects based on object identifiers and domain identifiers; and
a mapping monitor executable by the processor to:
responsive to determining that the operation on the object can proceed based on the domain isolation rules, access user mapping rules that map specified users allowed to perform a specified operation to a specified object; and
determine whether the operation can proceed on the object by the user based on the user mapping rules.

9. The system of claim 8, wherein the mapping monitor is executable by the processor to:
determine whether the user is mapped to the operation based on the user mapping rules; and
responsive to determining that the user is not mapped to the operation, deny the operation.

10. The system of claim 8, wherein the mapping monitor is executable by the processor to:
determine whether the user is mapped to the operation based on the user mapping rules; and
responsive to determining that the user is mapped to the operation, permit the operation.

11. The system of claim 8, wherein the user mapping rules include a mapping of users permitted to perform the operation on the object, and wherein the mapping monitor is executable by the processor to determine whether the user attempting to perform the operation on the object is included in the mapping.

12. The system of claim 8, wherein the user mapping rules include a mapping of users permitted to perform the operation on the object based on an owner of the object, and wherein the mapping monitor is executable by the processor to determine whether the user attempting to perform the operation on the object is included in the mapping.

13. A computer program product for domain based user mapping of objects, the computer program product comprising:
a computer readable storage medium having computer readable program code embodied therewith, the computer readable program code comprising computer readable program code configured to:
responsive to determining that an operation is being attempted on an object identified with an object identifier, determine a domain identifier associated with a user attempting the operation;
determine whether the operation can proceed on the object based on domain isolation rules, the domain isolation rules indicating rules for allowing or disallowing operations to proceed on objects based on object identifiers and domain identifiers;
responsive to determining that the operation on the object can proceed based on the domain isolation rules, access user mapping rules that map specified users allowed to perform a specified operation to a specified object; and
determine whether the operation can proceed on the object by the user based on the user mapping rules.

14. The computer program product of claim 13, wherein the computer readable program code is configured to:
determine whether the user is mapped to the operation based on the user mapping rules; and
responsive to determining that the user is not mapped to the operation, deny the operation.

15. The computer program product of claim 13, wherein the computer readable program code is configured to:
determine whether the user is mapped to the operation based on the user mapping rules; and
responsive to determining that the user is mapped to the operation, permit the operation.

16. The computer program product of claim 13, wherein the computer readable program code is configured to:
store the user mapping rules to include a mapping of users permitted to perform the operation on the object; and
determine whether the user attempting to perform the operation on the object is included in the mapping.

17. The computer program product of claim 13, wherein the computer readable program code is configured to:
store the user mapping rules to include a mapping of users permitted to perform the operation on the object based on an owner of the object; and
determine whether the user attempting to perform the operation on the object is included in the mapping.

18. The computer program product of claim 13, wherein the computer readable program code is configured to:
store the user mapping rules to include, for each user mapping rule, an owner of a mapped object, a mapped operation that may be performed on the mapped object, and an identification of one or more mapped users permitted access to the mapped object for the mapped operation; and
determine whether the operation can proceed on the object by the user by verifying the user attempting the operation is a mapped user and that the operation being attempted is a mapped operation.

19. A method, comprising:
receiving an identifier of an object on which an operation is being attempted;
determining a domain associated with a user attempting the operation;
verifying that the operation can proceed on the object based on the domain and the identifier;
accessing mapping rules defining a set of users permitted to perform a designated operation on the object;
verifying that the user attempting the operation on the object is included in the defined set of users for the object; and
verifying that the operation being attempted by the user is designated in the mapping rules as a designated operation permitted by the user for the object.

20. The method of claim 19, further comprising storing the mapping rules based on an owner of the object.

21. The method of claim 20, further comprising verifying that the user attempting the operation is mapped to the owner of the object based on the mapping rules.

22. The method of claim 21, further comprising:
determining a user identifier with the user; and
verifying that the user identifier is associated with the domain.

23. The method of claim 19, further comprising:
storing the mapping rules to include, for each mapping rule, an owner of a mapped object, a mapped operation that may be performed on the mapped object, and an identification of one or more mapped users permitted access to the mapped object for the mapped operation; and
wherein verifying that the operation being attempted by the user is designated in the mapping rules comprises verifying the user attempting the operation is a mapped user and that the operation being attempted is a mapped operation.
